(19) United States
(12) Patent Application Publication
(10) Pub. No.: US 2025/0355787 A1
(43) Pub. Date: Nov. 20, 2025

(54) SOFTWARE DEVELOPMENT BY INCREMENTAL SOFTWARE PART TEST AND RELEASE

(71) Applicant: TOYOTA JIDOSHA KABUSHIKI KAISHA, Aichi-ken (JP)

(72) Inventors: Matthew VERN, Tokyo-to (JP); Emma CAUNTER, Tokyo-to (JP)

(21) Appl. No.: 18/665,485

(22) Filed: May 15, 2024

(51) Int. Cl. G06F 11/36; G06F 8/65

(52) U.S. Cl. CPC G06F 11/368; G06F 8/65

(57) ABSTRACT

Software development by incremental software part test and release is performed by detecting an update of a hardware communication specification, building a new version of an upstream software part in a software system based on the updated hardware communication specification, testing the new version of the upstream software part, and in response to the testing of the new version of the upstream software part being successful, releasing the new version of the upstream software part in the software system, building a new version of a downstream software part based on the new version of the upstream software part, testing the new version of the downstream software part, and in response to the testing of the new version of the downstream software part being successful, releasing the new version of the downstream software part in the software system.

### BACKGROUND

Software systems, such as software systems for vehicles, include multiple software parts, with some software parts depending on other software parts as part of a build process. Updating any software part of a software system requires rebuilding of the software system. The rebuilt software system is tested to verify functionality. If the software system passes testing, then the software system is released as a new version. If the software system does not pass testing, then the software system is not released.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of software system development for software development by incremental software part test and release, according to at least some embodiments of the subject disclosure.

FIG. 2 is an operational flow for software development by incremental software part test and release, according to at least some embodiments of the subject disclosure.

FIG. 3 is an operational flow for building new versions of software parts, according to at least some embodiments of the subject disclosure.

FIG. 4 is a block diagram of a hardware configuration for software development by incremental software part test and release, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In software systems known to the inventors, rebuilding the software system involves rebuilding of any software parts that depend on the initially updated software part, either directly or indirectly. In such software systems, one or more rebuilt software parts among the software system may actually be functioning properly. Developers manually review each software part to determine the cause of testing failure, and test the software system repeatedly until the software system passes testing.

In at least some embodiments of the subject disclosure, each software part among the initially updated software part and any software parts that depend on the initially updated software part, either directly or indirectly, are tested individually to verify local functionality. In at least some embodiments, software parts that pass testing are released as updated software parts, and developers are notified of software parts that do not pass testing.

In at least some embodiments, by testing software parts individually, issues become known earlier in the building process, reducing time and resources in building dependent software parts, and developers are directed to issues with specific software parts, reducing analysis time.

For example, application of rain response is considered, in which the application detects weather via a sensor, and if the detected weather includes rain, then the vehicle's windows are closed in order to protect the inside of the case from water damage. In this example, the vehicle system is broken down into four software parts: weather, central, window and I/O. In this example, the rain response application causes these subsystems to communicate with each other. In at least some embodiments, one such communication is weather data from the weather subsystem to the central subsystem. In at least some embodiments, if the abstraction layer does not currently define a signal or data type associated with the weather data, then the hardware communication specification is updated to include a new signal or data type for “weather data”. In at least some embodiments, updating of the hardware communication specification triggers testing and updating of an abstraction layer, which triggers testing and updating of all layers through the system layer.

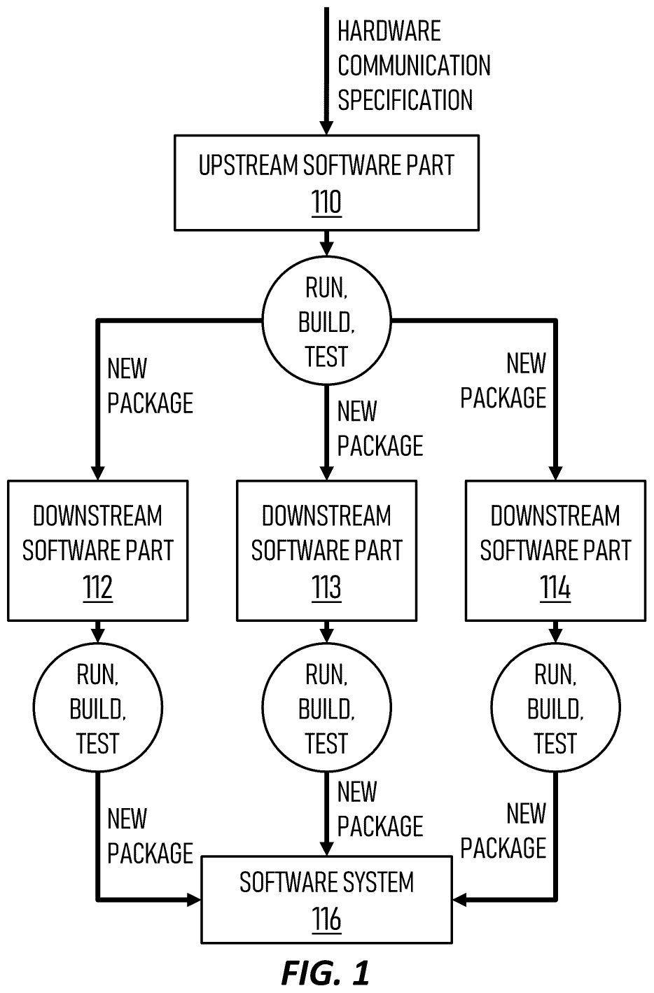

FIG. 1 is a schematic diagram of software system development for software development by incremental software part test and release, according to at least some embodiments of the subject disclosure. The diagram includes upstream software part 110, downstream software parts 112, 113, and 114, and software system 116.

Upstream software part 110 is initially updated in response to an updated hardware communication specification. In at least some embodiments, the hardware communication specification includes a list of signals and data types usable by the software system. In at least some embodiments, the hardware communication specification is for a Controller Area Network (CAN) of a vehicle. In at least some embodiments, upstream software part 110 is configured to provide functionality for downstream software parts 112, 113, 114. In at least some embodiments, upstream software part 110 is configured to handle tasks like data processing or user interface management. In at least some embodiments, upstream software part 110 is configured to interact with external APIs, databases, or other software systems outside of software system. 116. In at least some embodiments, upstream software part 110 is a device driver, a library, or a service in a microservices architecture.

Downstream software parts 112, 113, and 114 are updated in response to successfully updating upstream software part 110, and each includes specific functions related to processing data or functionality received from the upstream part. In at least some embodiments, downstream software parts 112, 113, 114 are configured to depend on upstream software part 110. In at least some embodiments, downstream software parts 112, 113, 114 are updated based on changes in upstream software part 110. In at least some embodiments, downstream software parts 112, 113, 114 are configured to be tested and released as new versions in response to passing the tests. In at least some embodiments, downstream software parts 112, 113, 114 may interact with each other based on the software system's design. In at least some embodiments, downstream software parts 112, 113, 114 are configured to handle a variety of tasks depending on their roles in the software system, such as weather detection, window manipulation, or controller interaction for a vehicle. In at least some embodiments, downstream software parts 112, 113, 114 are configured to interact with other software parts in the system or external components like databases, APIs, or hardware devices. In at least some embodiments, downstream software parts 112, 113, 114 are modules in a monolithic application, services in a microservices architecture, or libraries used by other parts of the system.

Software system 116 is built from all the software parts (110, 112, 113, 114), and provides the overall functionality of the application. In at least some embodiments, software system 116 is the overall system that includes all the software parts. In at least some embodiments, software system 116 is configured to interact with all the software parts 110, 112, 113, 114 and coordinates their operation. In at least some embodiments, software system 116 is configured to provide a wide range of functionalities depending on the application, from data processing and storage to user interface rendering and business logic implementation. In at least some embodiments, software system 116 is configured for vehicle operation. In at least some embodiments, software system 116 includes the application that the end-users interact with or that provides services to other systems.

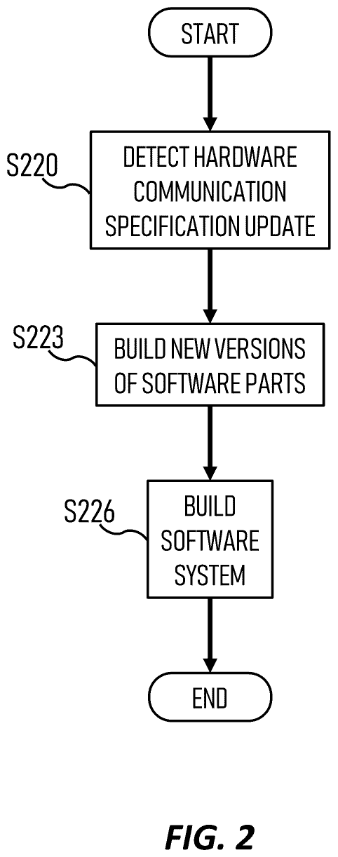

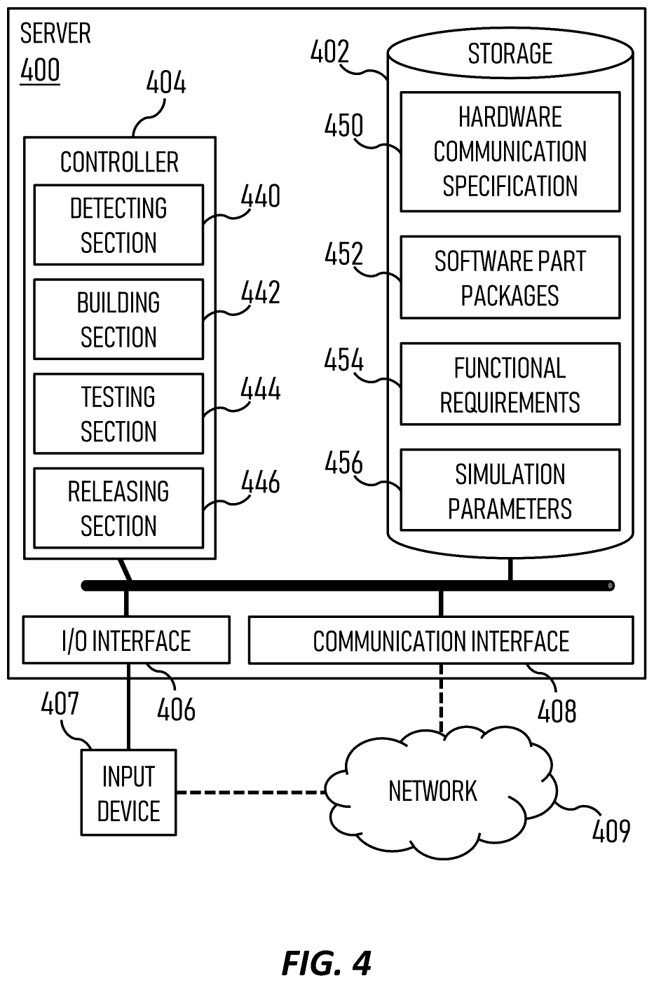

FIG. 2 is an operational flow for software development by incremental software part test and release, according to at least some embodiments of the subject disclosure. In at least some embodiments, the operational flow provides a method of an operational flow for software development by incremental software part test and release, according to at least some embodiments of the subject disclosure. In at least some embodiments, the method is performed by a controller of a server, such as controller 402 of server 400 of FIG. 4, described hereinafter.

At S220, the controller or a section thereof detects hardware communication specification updates. In at least some embodiments, the controller monitors the hardware communication specification for any changes or updates. In at least some embodiments, the controller detects an update of a hardware communication specification. In at least some embodiments, the controller monitors through automated systems that track changes in the specification documents or databases. In at least some embodiments, the controller causes software parts that interact with the hardware to be updated in response to the detection of an updated hardware communication specification. In at least some embodiments, the controller initiates a series of actions in the software development process. In at least some embodiments, the controller monitors the hardware communication specification constantly.

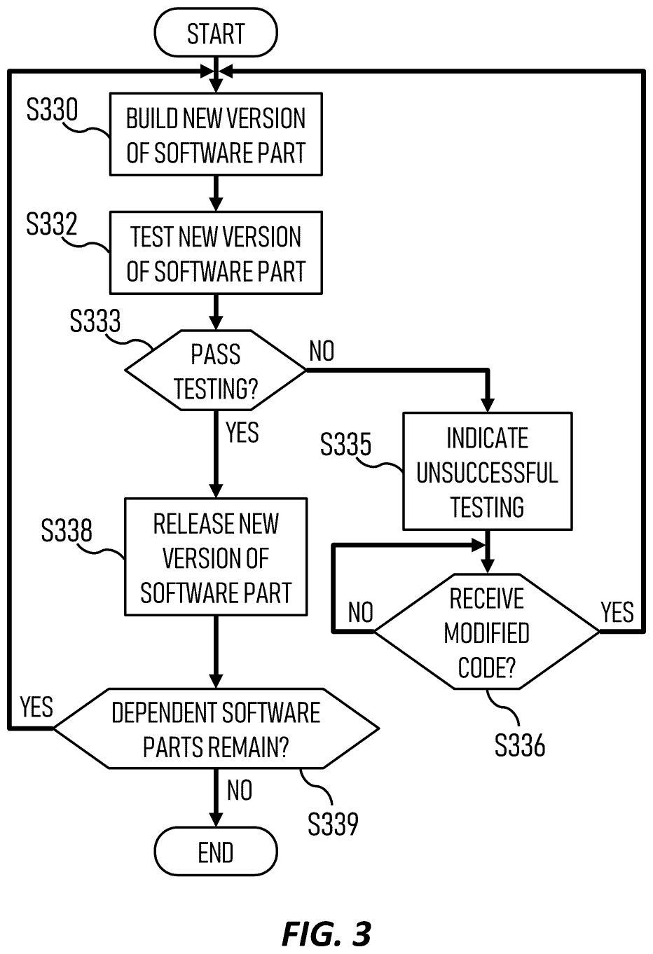

At S223, the controller or a section thereof builds new versions of software parts. In at least some embodiments, the controller builds new versions of the affected software parts based on the detected hardware communication specification update. In at least some embodiments, the controller compiles code to create executable packages of software parts. In at least some embodiments, the controller creates new versions of the software parts that are compatible with the updated hardware communication specification. In at least some embodiments, the controller performs the operational flow of FIG. 3, described hereinafter. In at least some embodiments, the controller determines that a plurality of downstream software parts depend on the upstream software part, the downstream software part among the plurality of downstream software parts.

At S226, the controller or a section thereof builds the software system. In at least some embodiments, the controller integrates the newly built software parts into the software system. In at least some embodiments, the tests the software system to verify overall functionality. In at least some embodiments, the controller utilizes a system builder or an automated build system to integrate the software parts. In at least some embodiments, the controller releases a new version of the software system.

FIG. 3 is an operational flow for building new versions of software parts, according to at least some embodiments of the subject disclosure. In at least some embodiments, the operational flow provides a method of an operational flow for building new versions of software parts, according to at least some embodiments of the subject disclosure. In at least some embodiments, the method is performed by a controller of a server, such as controller 402 of server 400 of FIG. 4, described hereinafter.

At S330, the controller or a section thereof builds a new version of a software part. In at least some embodiments, the controller builds a new version of an upstream software part in a software system based on the updated hardware communication specification. In at least some embodiments, the controller creates a new version of a software part based on updated specifications or dependencies. In at least some embodiments, the controller creates a new version of a software part based on a new version of an upstream software part. In at least some embodiments, the controller determines that the downstream software part depends on the upstream software part before building the new version of the downstream software part. In at least some embodiments, the controller rebuilds the downstream software part in response to receiving a modified code of the downstream software part. In at least some embodiments, the building the new version of the downstream software part includes building a new version of each among the plurality of downstream software parts. In at least some embodiments, the controller builds a new version of a further downstream software part based on the new version of the downstream software part further in response to the testing of the new version of the downstream software part being successful. In at least some embodiments, the controller builds a new version of the software system based on the new version of each among the plurality of downstream software parts in response to the testing of the new version of each among the plurality of downstream software parts being successful.

At S332, the controller or a section thereof tests the new version of the software part. In at least some embodiments, the controller tests the new version of the upstream software part. In at least some embodiments, the controller conducts various tests on the newly built software part to verify its functionality and compatibility. In at least some embodiments, the testing the new version of the upstream software part includes determining one or more functional requirements of the upstream software part. In at least some embodiments, the testing the new version of the upstream software part includes testing functionality specific to the upstream software part. In at least some embodiments, the controller utilizes a simulator to conduct the testing. In at least some embodiments, the testing the new version of the upstream software part includes simulating a hardware component. In at least some embodiments, the testing the new version of the downstream software part includes testing the new version of each among the plurality of downstream software parts. In at least some embodiments, the controller tests the new version of the further downstream software part. In at least some embodiments, the controller uses a set of pre-written tests to conduct the testing of the simulated system. In at least some embodiments, the pre-written tests are each designed to test a unique aspect of a package at any or all layers of the software system.

At S333, the controller or a section thereof determines whether the new version of the software part passes the testing. In response to the new version of the software part not passing the testing, the operational flow proceeds to indicate unsuccessful testing at S335. In response to the new version of the software part passing the testing, the operational flow proceeds to determine whether a modified package is received at S336. In at least some embodiments, the controller evaluates the results of the testing process. In at least some embodiments, the controller compares output of the new version of the software part with expected output. In at least some embodiments, the new version of the software part passes the testing only when all tests have yielded correct output.

At S335, the controller or a section thereof indicates unsuccessful testing. In at least some embodiments, the controller indicates, in response to the testing of the new version of the downstream software part not being successful, unsuccessful testing of the downstream software part. In at least some embodiments, the controller notifies the relevant parties about the unsuccessful test results. In at least some embodiments, the controller transmits notifications to developers. In at least some embodiments, the controller includes a name and a version of the software part in the indication. In at least some embodiments, the controller maintains the new version of the upstream software part in response to the testing of the new version of the downstream software part not being successful.

At S336, the controller or a section thereof determines whether a modified code is received. In response to receiving a modified code, the operational flow returns to build a new version of the software part at S330. In response to not receiving a modified code, the operational flow returns to determine whether a modified package is received at S336. In at least some embodiments, the controller repeatedly checks if a modified code of the software part has been received.

At S338, the controller or a section thereof releases the new version of the software part. In at least some embodiments, the controller releases the new version of the software part into a repository of the software part. In at least some embodiments, this operation does not cause any external actions. In at least some embodiments, the controller makes the updated software part available for further updated of the software system. In at least some embodiments, in response to the testing of the new version of the upstream software part being successful, the controller releases the new version of the upstream software part in the software system, builds a new version of a downstream software part based on the new version of the upstream software part, tests the new version of the downstream software part, and in response to the testing of the new version of the downstream software part being successful, releases the new version of the downstream software part in the software system.

At S339, the controller or a section thereof determines whether there are remaining dependent software parts. In response to remaining dependent software parts, the operational flow returns to build a new version of a software part at S330. In response to no remaining dependent software parts, the operational flow ends. In at least some embodiments, the controller checks if there are any remaining software parts that depend on the newly released software part. In at least some embodiments, the controller refers to a predetermined sequence of software parts to build.

In at least some embodiments, the building and the testing of the new version of the downstream software part is performed in parallel with the building and the testing of the new version of each other among the plurality of downstream software parts.

FIG. 4 is a block diagram of a hardware configuration for software development by incremental software part test and release, according to at least some embodiments of the subject disclosure.

The exemplary hardware configuration includes server 400, which interacts with input device 407 directly or through network 409. In at least some embodiments, input device 407 is a touch screen, a microphone, a camera, or any other device configured to detect tactile, aural, visual, etc. input. In at least some embodiments, network 409 is an ethernet network, a Controller Area Network (CAN), or any other wired or wireless network or a combination thereof. In at least some embodiments, server 400 is a computer or other computing device that receives input or commands from input device 407. In at least some embodiments, server 400 is integrated with input device 407. In at least some embodiments, server 400 is a computer system that executes computer-readable instructions to perform operations for software development by incremental software part test and release.

Server 400 includes a controller 402, a storage 404, an input/output interface 406, and a communication interface 408. In at least some embodiments, controller 402 includes a processor or programmable circuitry executing instructions to cause the processor or programmable circuitry to perform operations according to the instructions. In at least some embodiments, controller 402 includes analog or digital programmable circuitry, or any combination thereof. In at least some embodiments, controller 402 includes physically separated storage or circuitry that interacts through communication. In at least some embodiments, storage 404 includes a non-volatile computer-readable medium capable of storing executable and non-executable data for access by controller 402 during execution of the instructions. In at least some embodiments, communication interface 408 transmits and receives data from network 409. In at least some embodiments, input/output interface 406 connects to various input and output units, such as input device 407, via a parallel port, a serial port, a keyboard port, a mouse port, a monitor port, and the like to accept commands and present information. In some embodiments, storage 404 is external from server 400.

Controller 402 includes detecting section 440, building section 442, testing section 444, and releasing section 446. Storage 404 includes hardware communication specification 450, software part packages 452, functional requirements 454, and simulation parameters 456.

Detecting section 440 is the circuitry or instructions of controller 402 configured to detect hardware communication specification updates. In at least some embodiments, detecting section 440 is configured to detect an update of a hardware communication specification. In at least some embodiments, detecting section 440 utilizes information in storage 404, such as hardware communication specification 450. In at least some embodiments, detecting section 440 includes sub-sections for performing additional functions, as described in the foregoing flow charts. In at least some embodiments, such sub-sections are referred to by a name associated with a corresponding function.

Building section 442 is the circuitry or instructions of controller 402 configured to build new versions of software parts. In at least some embodiments, building section 442 is configured to build a new version of an upstream software part in a software system based on the updated hardware communication specification. In at least some embodiments, building section 442 records information in storage 404, such as software part packages 452. In at least some embodiments, building section 442 includes sub-sections for performing additional functions, as described in the foregoing flow charts. In at least some embodiments, such sub-sections are referred to by a name associated with a corresponding function.

Testing section 444 is the circuitry or instructions of controller 402 configured to test new versions of software parts. In at least some embodiments, testing section 444 is configured to test the new version of the upstream software part. In at least some embodiments, building section 442 utilizes information in storage 404, such as functional requirements 454 and simulation parameters 456. In at least some embodiments, testing section 444 includes sub-sections for performing additional functions, as described in the foregoing flow charts. In at least some embodiments, such sub-sections are referred to by a name associated with a corresponding function.

Releasing section 446 is the circuitry or instructions of controller 402 configured to release new versions of software parts. In at least some embodiments, releasing section 446 is configured to release the new version of the upstream software part in the software system. In at least some embodiments, releasing section 446 utilizes information in storage 404, such as software part packages 452. In at least some embodiments, releasing section 446 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, software development by incremental software part test and release is performed by detecting an update of a hardware communication specification, building a new version of an upstream software part in a software system based on the updated hardware communication specification, testing the new version of the upstream software part, and in response to the testing of the new version of the upstream software part being successful, releasing the new version of the upstream software part in the software system, building a new version of a downstream software part based on the new version of the upstream software part, testing the new version of the downstream software part, and in response to the testing of the new version of the downstream software part being successful, releasing the new version of the downstream software part in the software system.

In at least some embodiments, software development by incremental software part test and release further includes indicating, in response to the testing of the new version of the downstream software part not being successful, unsuccessful testing of the downstream software part. In at least some embodiments, software development by incremental software part test and release further includes maintaining the new version of the upstream software part in response to the testing of the new version of the downstream software part not being successful. In at least some embodiments, software development by incremental software part test and release further includes rebuilding the downstream software part in response to receiving a modified package of the downstream software part. In at least some embodiments, the testing the new version of the upstream software part includes testing functionality specific to the upstream software part. In at least some embodiments, the testing the new version of the upstream software part includes determining one or more functional requirements of the upstream software part. In at least some embodiments, the testing the new version of the upstream software part includes simulating a hardware component. In at least some embodiments, the hardware communication specification includes a list of signals and data types usable by the software system. In at least some embodiments, the hardware communication specification is for a Controller Area Network (CAN) of a vehicle. In at least some embodiments, software development by incremental software part test and release further includes determining that the downstream software part depends on the upstream software part before building the new version of the downstream software part. In at least some embodiments, software development by incremental software part test and release further includes determining that a plurality of downstream software parts depend on the upstream software part, the downstream software part among the plurality of downstream software parts. In at least some embodiments, software development by incremental software part test and release further includes where in the building the new version of the downstream software part includes building a new version of each among the plurality of downstream software parts, and wherein the testing the new version of the downstream software part includes testing the new version of each among the plurality of downstream software parts. In at least some embodiments, the building and the testing of the new version of the downstream software part is performed in parallel with the building and the testing of the new version of each other among the plurality of downstream software parts. In at least some embodiments, software development by incremental software part test and release further includes building a new version of a further downstream software part based on the new version of the downstream software part further in response to the testing of the new version of the downstream software part being successful, and testing the new version of the further downstream software part. In at least some embodiments, software development by incremental software part test and release further includes building a new version of the software system based on the new version of each among the plurality of downstream software parts in response to the testing of the new version of each among the plurality of downstream software parts being successful.

In at least some embodiments, software development by incremental software part test and release is performed by a processor executing instructions in accordance with the foregoing operations or a device comprising a controller including circuitry configured to perform the foregoing operations.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium having instructions recorded thereon that, in response to execution by one or more processors, cause performance of operations comprising:
detecting an update of a hardware communication specification;
building a new version of an upstream software part in a software system based on the updated hardware communication specification;
testing the new version of the upstream software part; and
in response to the testing of the new version of the upstream software part being successful,
releasing the new version of the upstream software part in the software system,
building a new version of a downstream software part based on the new version of the upstream software part,
testing the new version of the downstream software part, and
in response to the testing of the new version of the downstream software part being successful, releasing the new version of the downstream software part in the software system.

2. The computer-readable medium of claim 1, wherein the operations further comprise
indicating, in response to the testing of the new version of the downstream software part not being successful, unsuccessful testing of the downstream software part.

3. The computer-readable medium of claim 2, wherein the operations further comprise
maintaining the new version of the upstream software part in response to the testing of the new version of the downstream software part not being successful.

4. The computer-readable medium of claim 2, wherein the operations further comprise
rebuilding the downstream software part in response to receiving a modified package of the downstream software part.

5. The computer-readable medium of claim 1, wherein the testing the new version of the upstream software part includes testing functionality specific to the upstream software part.

6. The computer-readable medium of claim 5, wherein the testing the new version of the upstream software part includes
determining one or more functional requirements of the upstream software part.

7. The computer-readable medium of claim 5, wherein the testing the new version of the upstream software part includes
simulating a hardware component.

8. The computer-readable medium of claim 1, wherein the hardware communication specification includes a list of signals and data types usable by the software system.

9. The computer-readable medium of claim 8, wherein the hardware communication specification is for a Controller Area Network (CAN) of a vehicle.

10. The computer-readable medium of claim 1, wherein the operations further comprise
determining that the downstream software part depends on the upstream software part before building the new version of the downstream software part.

11. The computer-readable medium of claim 10, wherein the operations further comprise
determining that a plurality of downstream software parts depend on the upstream software part, the downstream software part among the plurality of downstream software parts.

12. The computer-readable medium of claim 11, wherein
the building the new version of the downstream software part includes building a new version of each among the plurality of downstream software parts, and
the testing the new version of the downstream software part includes testing the new version of each among the plurality of downstream software parts.

13. The computer-readable medium of claim 12, wherein the building and the testing of the new version of the downstream software part is performed in parallel with the building and the testing of the new version of each other among the plurality of downstream software parts.

14. The computer-readable medium of claim 12, wherein the operations further comprise
building a new version of a further downstream software part based on the new version of the downstream software part further in response to the testing of the new version of the downstream software part being successful, and
testing the new version of the further downstream software part.

15. The computer-readable medium of claim 12, wherein the operations further comprise
building a new version of the software system based on the new version of each among the plurality of downstream software parts in response to the testing of the new version of each among the plurality of downstream software parts being successful.

16. A method comprising:
detecting an update of a hardware communication specification;
building a new version of an upstream software part in a software system based on the updated hardware communication specification;
testing the new version of the upstream software part; and
in response to the testing of the new version of the upstream software part being successful,
releasing the new version of the upstream software part in the software system,
building a new version of a downstream software part based on the new version of the upstream software part,
testing the new version of the downstream software part, and
in response to the testing of the new version of the downstream software part being successful, releasing the new version of the downstream software part in the software system.

17. The method of claim 16, further comprising
indicating, in response to the testing of the new version of the downstream software part not being successful, unsuccessful testing of the downstream software part.

18. The method of claim 17, further comprising
maintaining the new version of the upstream software part in response to the testing of the new version of the downstream software part not being successful.

19. The method of claim 17, further comprising
rebuilding the downstream software part in response to receiving a modified package of the downstream software part.

20. A device comprising:
a controller including circuitry configured to perform operations including
detecting an update of a hardware communication specification,
building a new version of an upstream software part in a software system based on the updated hardware communication specification,
testing the new version of the upstream software part, and
in response to the testing of the new version of the upstream software part being successful,
releasing the new version of the upstream software part in the software system,
building a new version of a downstream software part based on the new version of the upstream software part,
testing the new version of the downstream software part, and
in response to the testing of the new version of the downstream software part being successful, releasing the new version of the downstream software part in the software system.
